(19) United States
(12) Patent Application Publication
(10) Pub. No.: US 2024/0011634 A1
(43) Pub. Date: Jan. 11, 2024

(54) CANDLE IGNITER DEVICE AND SYSTEM

(71) Applicant: IRAJ KARIMI, CARLSBAD, CA (US)

(72) Inventor: IRAJ KARIMI, CARLSBAD, CA (US)

(21) Appl. No.: 18/348,842

(22) Filed: Jul. 7, 2023

Related U.S. Application Data
(60) Provisional application No. 63/359,810, filed on Jul. 9, 2022.

(51) Int. Cl. F23Q 3/00; F23Q 2/24; C11C 5/00; F23Q 2/28

(52) U.S. Cl. CPC F23Q 3/006; F23Q 2/24; C11C 5/006; F23Q 2/285

(57) ABSTRACT

An electronically controlled igniter device for a wick-containing item, and methods of use thereof, is described. The device is particularly advantageous in that it provides a convenient and safe device for igniting and optionally extinguishing the flame of a wick-containing item. The wick-containing item may be a standalone object, or a set of multiple electrically interconnected objects that can be individually controlled, or several groups of such objects may be remotely or locally controlled.

### CROSS-REFERENCE TO RELATED APPLICATIONS

This application claims the benefit of U.S. Provisional Application No. 63/359,810, filed Jul. 9, 2022. The entire contents of the aforementioned application are herein incorporated by reference in their entirety.

### FIELD OF THE INVENTION

The present disclosure provides an electronically controlled igniter device for a wick-containing item, and methods of use thereof. The device is particularly advantageous in that it provides a convenient and safe device for igniting and optionally extinguishing the flame of a wick-containing item.

### BACKGROUND

Existing products such as candles, lanterns, torches, and other products that employ a wick require a user to apply a flame to the exposed wick via a match, a lighter, or other similar device having an open flame. Such prior art products thus facilitate ignition of the wick through the use of a second incendiary device or product. Igniting an exposed wick can be a clumsy process, with a user required to physically bring the wick of the object into close proximity with the ignition flame, in order to ignite the wick with the exposed flame. Such action often causes burns to a user's fingers, or may require the user to increase the size of the flame to an unsafe level in order to effect ignition of the object candle or other wick-containing product.

Further, once a desired wick-containing product is ignited, a user must also typically apply a device to the burning wick to snuff out the existing flame, or apply a strong stream of air in order to cause the flame to effectively “blow out”. Again, applying a flame to ignite the wick, and/or to extinguish the flame of the burning wick, requires the user to closely act upon the wick in an unsafe manner, and close proximity of the user to the flame typically causes burns to a user's finger(s), and possibly other areas, including a user's hair.

The following disclosed device and system, including the methods of use thereof, solve the shortcomings of such dangerous activities for many types of candles and similar products, while also providing simultaneous convenience when interacting with a wick.

### BRIEF DESCRIPTION OF THE FIGURES

FIG. 1 is a schematic diagram of an example candle igniter device, system, and method of use.

FIG. 2 is a schematic diagram of another example candle igniter device, system, and method of use.

FIG. 3 is a schematic diagram of an example extinguishing device and method of use.

FIG. 4 is a schematic diagram of an example igniter and extinguishing device in which a multi-way switch is incorporated.

FIG. 5 is a schematic diagram of another example igniter and extinguishing device in which another type of multi-way switch is incorporated.

### SUMMARY OF THE INVENTION

In an embodiment, there is provided an electronic arc generating system comprising a power supply; a transistor; a diode; a transformer; a pair of electrodes; a low-voltage generating subsystem comprising a first switch and a first resistor, wherein the low-voltage generating subsystem is configured to ignite a combustible component; and a high-voltage generating subsystem comprising a second switch and a second resistor, wherein the high-voltage generating subsystem is configured to extinguish a flame of a combustible component, wherein the power supply, transistor, diode, transformer, pair of electrodes, the low-voltage generating subsystem and the high-voltage generating subsystem, are all electrically interconnected.

In another embodiment, there is provided an electronic arc generating system as described herein, wherein the power supply is a rechargeable power supply.

In a further embodiment, there is provided an electronic arc generating system as described herein, wherein the power supply is a removable power supply.

In yet another embodiment, there is provided an electronic arc generating system as described herein, wherein the combustible component comprises a candle wick.

In still another embodiment, there is provided an electronic arc generating system as described herein, wherein the combustible component comprises a gaseous component.

In another embodiment, there is provided an electronic arc generating system as described herein, wherein the low-voltage generating subsystem produces an output across the pair of electrodes of about 20 kilovolts.

In a further embodiment, there is provided an electronic arc generating system as described herein, wherein the high-voltage generating subsystem produces an output across the pair of electrodes of about 60 to 70 kilovolts.

In yet another embodiment, there is provided a combination electronic arc ignition and extinguishment system comprising a power supply; a transistor; a diode; a transformer; a pair of electrodes; a low-voltage generating subsystem comprising a first switch and a first resistor; and a high-voltage generating subsystem comprising a second switch and a second resistor, wherein the power supply, transistor, diode, transformer, pair of electrodes, the low-voltage generating subsystem and the high-voltage generating subsystem, are all electrically interconnected.

In still another embodiment, there is provided a combination electronic arc ignition and extinguishment system as described herein, wherein the low-voltage generating subsystem is configured to ignite a combustible component.

In another embodiment, there is provided a combination electronic arc ignition and extinguishment system as described herein, wherein the high-voltage generating subsystem is configured to extinguish a flame of a combustible component.

In a further embodiment, there is provided a combination electronic arc ignition and extinguishment system as described herein, wherein the power supply is a rechargeable power supply.

In yet another embodiment, there is provided a combination electronic arc ignition and extinguishment system as described herein, wherein the power supply is a removable power supply.

In still another embodiment, there is provided a combination electronic arc ignition and extinguishment system as described herein, wherein the combustible component comprises a candle wick.

In another embodiment, there is provided a combination electronic arc ignition and extinguishment system as described herein, wherein the combustible component comprises a gaseous component.

In a further embodiment, there is provided a combination electronic arc ignition and extinguishment system as described herein, wherein the low-voltage generating subsystem produces an output across the pair of electrodes of about 20 kilovolts.

In yet another embodiment, there is provided a combination electronic arc ignition and extinguishment system as described herein, wherein the high-voltage generating subsystem produces an output across the pair of electrodes of about 60 to 70 kilovolts.

In still another embodiment, there is provided a combination electronic arc ignition and extinguishment system comprising: a power supply; a transistor; a diode; a transformer; a pair of electrodes; a low-voltage generating subsystem comprising a first resistor; a high-voltage generating subsystem comprising a second resistor; and a 3-way switch located upstream of the low-voltage generating subsystem and the high-voltage generating subsystem, wherein the 3-way switch is configured to separately engage the low-voltage generating subsystem or the high-voltage generating subsystem, or to simultaneously engage both the low-voltage generating subsystem and the high-voltage generating subsystem, wherein the power supply, transistor, diode, transformer, pair of electrodes, 3-way switch, the low-voltage generating subsystem and the high-voltage generating subsystem, are all electrically interconnected.

In another embodiment, there is provided a combination electronic arc ignition and extinguishment system as described herein, wherein the first resistor of the low-voltage generating subsystem provides a resistance value of about 50 ohms.

In a further embodiment, there is provided a combination electronic arc ignition and extinguishment system as described herein, wherein the second resistor of the high-voltage generating subsystem provides a resistance value of about 100 ohms.

Throughout this disclosure, the term “switch” encompasses specifically described embodiments, and also includes both mechanical and electrical switch variations of such embodiments readily understood by one of ordinary skill in the art. For example, where a multi-way switch is disclosed, the multi-way switch may include an ON-OFF switch, an intermittent ON-OFF switch, a pulsed electric or mechanical switch, a mechanical or electrical push-type switch, a 2-way switch, a 3-way switch, a 4-way switch, any combination thereof, and the like. A push-button spring switch encompasses both a mechanical, spring-enabled switch and an electrical switch that functions equivalent to a push-button spring switch. Where a switch is described as a mechanical switch, an electrical equivalent switch may also be used. Where a switch is described as an electrical switch, an equivalent mechanical switch may also be used. Where a switch is described as a mechanical switch and/or an electrical switch, a combination electrical-mechanical switch may also be used. One or more switches in the present disclosure may be configured in either a parallel, series, or combination parallel-series circuit. Depending on the fuel source employed in one or more embodiments of the disclosure, a switch can be a push-button or electronic switch to produce output of a corresponding spark. The term “electric” may also be used interchangeably with “electronic” throughout this disclosure.

In one or more embodiments throughout this disclosure, one or more switches may be engaged electronically or mechanically for a period of about 1 to 7 seconds, about 1 to 2 seconds, about 1 to 3 seconds, about 2 to 3 seconds, about 1 to 4 seconds, about 2 to 4 seconds, about 3 to 4 seconds, about 1 to 5 seconds, about 2 to 5 seconds, about 3 to 5 seconds, about 4 to 5 seconds, about 1 to 6 seconds, about 2 to 6 seconds, about 3 to 6 seconds, about 4 to 6 seconds, about 5 to 6 seconds, about 2 to 7 seconds, about 3 to 7 seconds, about 4 to 7 seconds, about 5 to 7 seconds, or about 6 to 7 seconds. The period of time for electronically or mechanically engaging the one or more switches may depend on user preference for the output of a low-voltage spark or a high-voltage spark as described herein. The term “engaged” means the switch is on the ON position for the period described, so that the switch is not required to be in a constant ON configuration; the switch may alternatively be “pulsed” or may be briefly in the ON position for the period described in this disclosure.

In one or more embodiments, an electronic eye sensor may be used to automatically control the ignition or extinguishment of the flame on a target device, depending on user preference and the particular electrical circuit configuration. The electronic eye sensor may also be used where electronic or mechanical switches are employed, or a combination of one or more electronic and/or mechanical switches in various configurations.

Certain exemplary embodiments (“examples”, “embodiments”, etc.) are described to provide an overall understanding of the principles of the function, structure, manufacture, use and preparation of the devices and methodology disclosed herein. While one or more embodiments and/or examples are described and illustrated in the accompanying drawings, one of ordinary skill in the relevant art will readily understand that the devices, processes, methods of use, relevant drawings, etc. specifically described herein are non-limiting exemplary embodiments and that the scope of the invention is defined by the accompanying claims in this disclosure. The features described, illustrated or exemplified with one or more embodiments may also be combined with the features of one or more other examples or embodiments. Such combinations, modifications, and variations are included within the scope of the presently described invention. One of ordinary skill in the art will appreciate and readily understand that the devices disclosed herein can have various configurations in addition to the examples and embodiments disclosed herein, and that the various features as disclosed herein in the various embodiments are interchangeable and able to be combined.

Exemplary embodiments described herein provide an overall understanding of the principles of the structure, function, manufacture, and use of the devices and methods disclosed herein. One or more examples of these embodiments are illustrated in the accompanying drawings. One of skill in the art will understand that the devices and methods described herein and illustrated in the accompanying drawings are non-limiting exemplary embodiments Features illustrated and/or described in connection with one exemplary embodiment may be combined with the features of one or more other embodiments; such modifications and variations are intended to be included within the scope of the present invention.

The following detailed description provides further disclosure with reference to the accompanying drawing(s).

### DETAILED DESCRIPTION

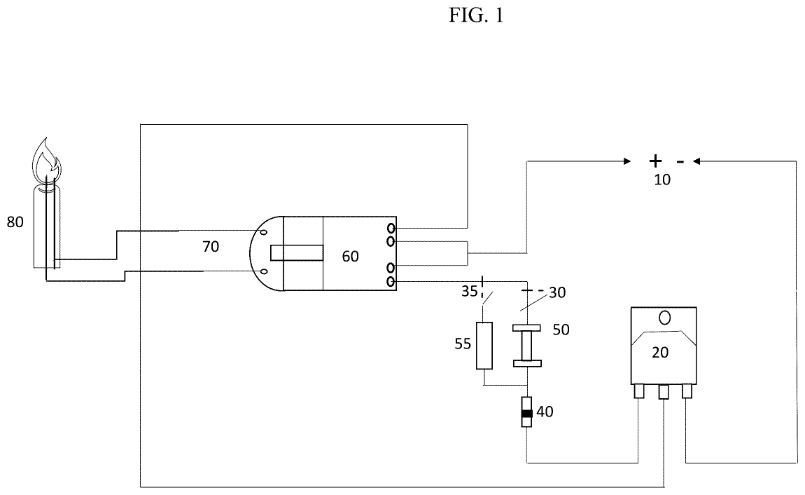

FIG. 1 provides an exemplary embodiment of a device according to the present disclosure. The components of the device are electrically interconnected as shown in FIG. 1. As shown in the exemplary embodiment of FIG. 1, the device is assembled by establishing electrically interconnected components. These components include a power supply (10), a transistor (20), a diode (40), an ON switch (30), an OFF switch (35), a resistor 1 (50) and resistor 2 (55), a transformer (60), a high-voltage output (70), and a wick-containing object (80). In one or more embodiments, the wick-containing object (80) is a candle. In one or more embodiments, the wick-containing object (80) may be a handheld or wall-mounted lantern, an upright torch, a tabletop torch, a candelabra, an altar candle or group of altar candles, a menorah, a pillar candle, a candle-type chandelier, a candle sconce, a hurricane lamp, and the like. The wick-containing object may be floor mounted, wall mounted, ceiling mounted, freestanding, or any combination thereof. The components as illustrated in the exemplary embodiment of FIG. 1 may also be arranged in one or more alternative configurations, provided electrical connectivity is maintained in such alternative configurations. Arrangement of the components may also include modular configurations in which one or more components are easily exchanged or “swapped” for another similar component in the system.

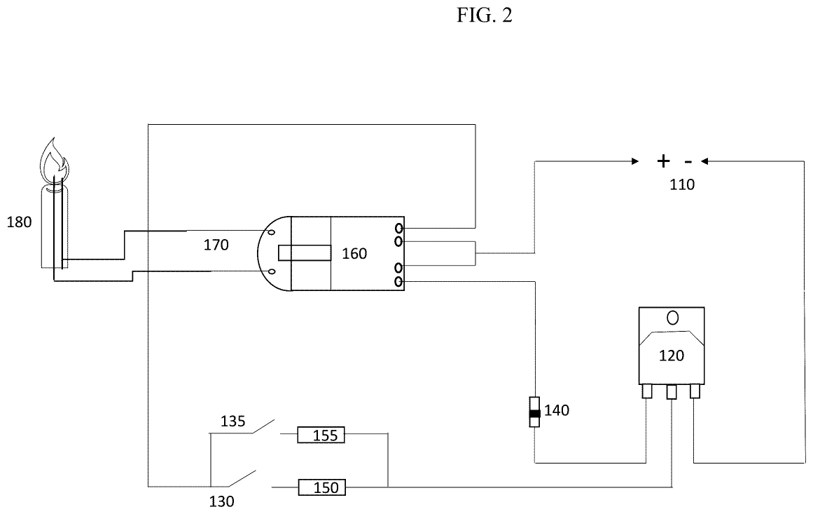

FIG. 2 provides an alternative exemplary embodiment of a device according to the present disclosure. The components of the device are electrically interconnected as shown in FIG. 2. As shown in the exemplary embodiment of FIG. 2, the device is assembled by establishing electrically interconnected components. These components include a power supply (110), a transistor (120), a diode (140), a switch 1A (130), a switch 2A (135), a resistor 1A (150), a resistor 2A (155), a transformer (160), a high-voltage output (170), and a wick-containing object (180). In one or more embodiments, the wick-containing object (180) is a candle. In one or more embodiments, the wick-containing object (180) is a candle. In one or more embodiments, the wick-containing object (180) may be a handheld or wall-mounted lantern, an upright torch, a tabletop torch, a candelabra, an altar candle or group of altar candles, a menorah, a pillar candle, a candle-type chandelier, a candle sconce, a hurricane lamp, and the like. The wick-containing object may be floor mounted, wall mounted, ceiling mounted, freestanding, or any combination thereof. The components as illustrated in the exemplary embodiment of FIG. 2 may also be arranged in one or more alternative configurations, provided electrical connectivity is maintained in such alternative configurations.

In the device exemplified in FIG. 1, ignition of the wick-containing object is accomplished by engaging the ON switch (30), so that closing of the electrical circuit causes the power supply (10) to provide power to the transformer (60) and causes current flow through transformer (6) into high-voltage output (70) wires to ignite a wick-containing object (80). High-voltage output (70) wires are arranged in close proximity so that electrical current generated by the transformer causes an electrical arc between the terminal ends of the respective high-voltage output (70) wires in the wick-containing object, causing an ignition flame that lights the wick. The output wires are also alternatively referred to herein as electrodes, or a pair of electrodes. In an embodiment, the high-voltage output comprises a range of 10 to 120 kV. In another embodiment, the high-voltage output comprises a range of 20 to 110 kV. In yet another embodiment, the high-voltage output comprises a range of 20 to 100 kV. In still another embodiment, the high-voltage output comprises a range of 20 to 90 kV. The voltage output and frequency can both be simultaneously or independently configured to a user's preferred ranges, depending on the device with which the presently described device and system may be used.

The power supply (10 in FIGS. 1 and 110 in FIG. 2) may be a battery, or an alternate power supply having AC or DC current to produce sufficient voltage for the device as described herein. For example, a 6V to 9V battery may be used for the power source, or a single or multitude of other batteries such as AA, AAA, C, D, or similar-sized batteries. Other similar batteries may also be used, including coin-type batteries (e.g., CR2032 or other sizes and configurations). A rechargeable battery, including a rechargeable system that is charged via a USB-type connector or similar charging connector, may be used with the device as disclosed herein. A rechargeable battery system may also be used with the device.

Example voltages of the power supply (10 in FIGS. 1 and 110 in FIG. 2) may range from about 10 to 120 kV. The higher voltage level is particularly advantageous in providing a pressure wave to extinguish an ignited wick.

In one or more embodiments, power supply (10 in FIGS. 1 and 110 in FIG. 2) may be a remotely-connected power source. For example, a cellular phone operably held in close proximity to the wick-containing object and thus operably interconnected to the electrical circuit of the present disclosure may also provide a power source and triggering event to engage the circuit to generate an ignition of the wick-containing object. Similarly, in such an embodiment, the cellular phone may also provide a remote trigger to disengage the flame and thus extinguish the flame on the wick.

In one or more embodiments, at least one of the individual components may be modular, so that the component(s) are easily exchanged. Also, components of FIG. 1 and FIG. 2 may be housed in a standalone configuration, such as a removable base or the like, for easily engageable and detachable configuration with a wick-containing object. In such embodiments, wick-containing object (80 in FIGS. 1 and 180 in FIG. 2) is removably engaged with high-voltage output (70 in FIG. 1, and 170 in FIG. 2).

In one or more embodiments, transformer (60 in FIGS. 1 and 160 in FIG. 2) may be a step-up transformer, so that low level power supply (10 in FIGS. 1 and 110 in FIG. 2) provides high current electrical flow to high voltage output wires. The output wires may also be referred to as electrodes throughout this disclosure. For example, power supply (10 in FIGS. 1 and 110 in FIG. 2) provides a current of about 20 kV from transformer (60 in FIGS. 1 and 160 in FIG. 2) to high-voltage output (70 in FIGS. 1 and 170 in FIG. 2). Transformer (60 in FIGS. 1 and 160 in FIG. 2) may supply an output range of about 20 to 100 kV.

In one or more embodiments, resistor 1 (50) and/or resistor 2 (55) in FIG. 1 comprise a range of about 100 to 700 ohms, or a range of about 120 to 600 ohms, or a range of about 150 to 300 ohms. Resistor 1 (50) and/or resistor 2 (55) in FIG. 1 may have the same or different resistor configuration and resistance capacity. In one or more embodiments, resistor 1A (150) and/or resistor 2A (155) in FIG. 2 comprises a range of about 100 to 700 ohms, or a range of about 120 to 600 ohms, or a range of about 150 to 300 ohms. Resistor 1A (150) and/or resistor 2A (155) in FIG. 2 may have the same or different resistor configuration and resistance capacity.

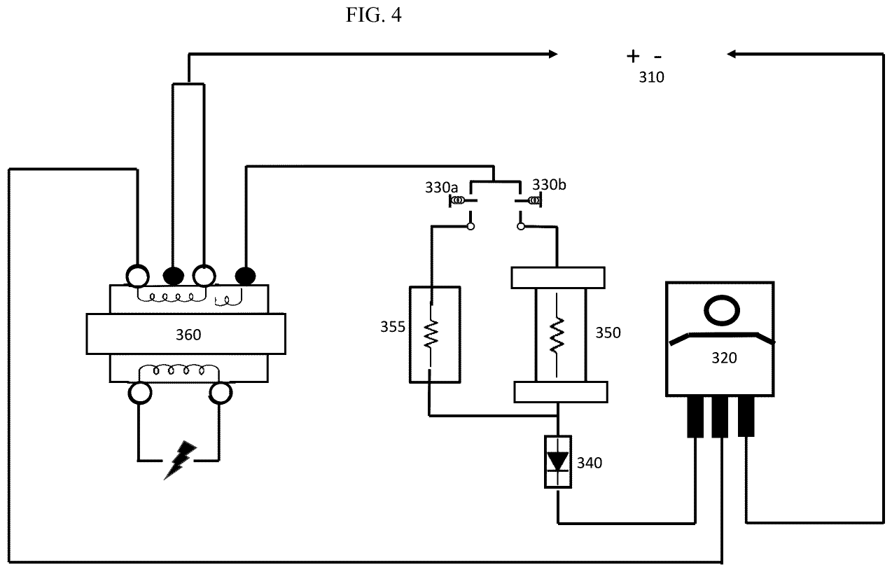

FIG. 4 provides an alternative exemplary embodiment of a device according to the present disclosure. The components of the device are electrically interconnected as shown in FIG. 4. As shown in the exemplary embodiment of FIG. 4, the device is assembled by establishing electrically interconnected components. These components include a power supply (310), a transistor (320), a diode (340), a pair of push-button spring switches (330a and 330b), a resistor 3A (350), a resistor 3B (355), a transformer (360), and a high-voltage output (370). In one or more embodiments, resistor 3A (350) and/or resistor 3B (355) in FIG. 4 comprise a range of about 50 to 700 ohms, or a range of about 50 to 150 ohms, or a range of about 120 to 600 ohms, or a range of about 150 to 300 ohms. Resistor 3A (350) and/or resistor 3B (355) in FIG. 4 may have the same or different resistor configuration and resistance capacity. In one example embodiment, resistor 3A (350) may comprise a resistance value of about 100 ohms, and resistor 3B (355) may comprise a resistance value of about 50 ohms. In this example embodiment, electrical current flowing through resistor 3A (350) may be referred to as a low-voltage current due to the relatively higher resistance value, while electrical current flowing through resistor 3B (355) may be referred to as a high-voltage current due to the relatively lower resistance value. In operation of this example device, either or both push-button switches (330a and 330b) may be engaged physically or electronically to switch between flow of high-current or low-voltage current. A low-voltage current provides sufficient spark energy at the output wires or electrodes to ignite a candle wick or other similar combustible component or material. This action may also be referred to as switching on the candle by igniting the wick to produce a flame. Alternatively, a user may also switch to allowing high-voltage current by again engaging (physically or electronically) push-button switch (330a) to a position that directs high-voltage current and yields a more significant spark output at wires or electrodes that is also referred to as a pressure wave to cause a flame on a burning wick or other similar combustible component to extinguish or “blow out” the flame. If push-button switch (330b) is physically or electronically engaged so that current flows through both resistor 3A (350) and resistor 3B (355), then the additive high-voltage current again produces a significant spark that is also referred to as a pressure wave to cause a flame on a burning wick or other similar combustible component to extinguish or “blow out” the flame. The present device thus is a dual use single device for both igniting and extinguishing a flame source through production of appropriate low-voltage or high-voltage output at wires or electrodes to turn on (ignite) or turn off (extinguish) a flame source. Accordingly, a user may operate the present device to switch between high-voltage output and low-voltage output to turn on or turn off a flame, both of which are accomplished using a single device according to this disclosure. This operation is clearly advantageous in that no matches or other flammable device are required, and a combustible gas or extinguishing gas also would not be necessary. This increased safety aspect of the present device is very advantageous to all user types and ages.

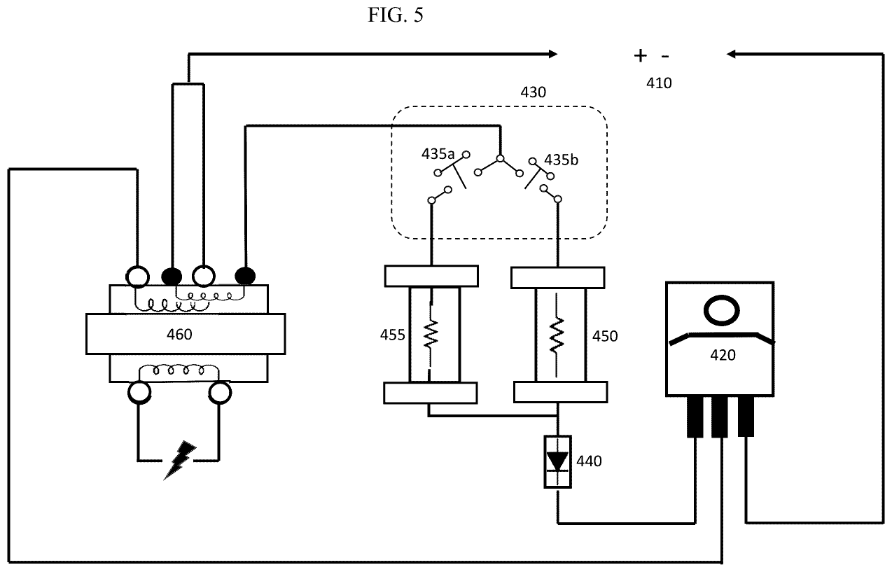

FIG. 5 illustrates an alternative exemplary embodiment of a device according to the present disclosure. The components of the device are electrically interconnected as shown in FIG. 5. As shown in the exemplary embodiment of FIG. 5, the device is assembled by establishing electrically interconnected components. These components include a power supply (410), a transistor (420), a diode (440), a multi-switch (430), a resistor 4A (450), a resistor 4B (455), a transformer (460), and a high-voltage output (470). In one or more embodiments, resistor 4A (450) and/or resistor 4B (455) in FIG. 5 comprise a range of about 50 to 700 ohms, or a range of about 50 to 150 ohms, or a range of about 120 to 600 ohms, or a range of about 150 to 300 ohms. Resistor 4A (450) and/or resistor 4B (455) in FIG. 5 may have the same or different resistor configuration and resistance capacity. In one example embodiment, resistor 4A (450) may comprise a resistance value of about 100 ohms, and resistor 4B (455) may comprise a resistance value of about 50 ohms. In this example embodiment, electrical current flowing through resistor 4A (450) may be referred to as a low-voltage current due to the relatively higher resistance value, while electrical current flowing through resistor 4B (455) may be referred to as a high-voltage current due to the relatively lower resistance value. In operation of this example device, multi-switch (430) may be engaged physically or electronically to switch between flow of high-current or low-voltage current. As exemplified, push-button switches (435a and 435b) are included in the multi-switch configuration, so that a user may select current flow through Resistor 4B (455), or through Resistor 4A (450), or a combination of both Resistor 4A (450) and Resistor 4B (455), or no electrical current flow by disengaging both push-button switches (435a and 435b). A low-voltage current provides sufficient spark energy at the output wires or electrodes to ignite a candle wick or other similar combustible component or material. This action may also be referred to as switching on the candle by igniting the wick to produce a flame. Alternatively, a user may also switch to allowing high-voltage current by again engaging (physically or electronically) multi-switch (430) to a position that directs high-voltage current and yields a more significant spark output at wires or electrodes that is also referred to as a pressure wave to cause a flame on a burning wick or other similar combustible component to extinguish or “blow out” the flame. If multi-switch (430) is physically or electronically engaged so that current flows through both resistor 4A (450) and resistor 4B (455), then the additive high-voltage current again produces a significant spark that is also referred to as a pressure wave to cause a flame on a burning wick or other similar combustible component to extinguish or “blow out” the flame. For example, depending on the power supply (410) incorporated in such an example device, resistor 4A (450) may provide a current of about 20 kvolts to flow therethrough, and resistor 4B (455) may provide a current of about 60-70 kvolts to flow therethrough. However, other values of both high- and low-voltage current may be adjusted by adjusting the power supply capability and output, and/or by varying the resistance configuration for Resistor 4A (450) and/or Resistor 4B (455). The present device thus is a dual use single device for both igniting and extinguishing a flame source through production of appropriate low-voltage or high-voltage output at wires or electrodes to turn on (ignite) or turn off (extinguish) a flame source. Accordingly, a user may operate the present device to switch between high-voltage output and low-voltage output to turn on or turn off a flame, both of which are accomplished using a single device according to this disclosure. This operation is clearly advantageous in that no matches or other flammable device are required, and a combustible gas or extinguishing gas also would not be necessary. This increased safety aspect of the present device is very advantageous to all user types and ages.

In another embodiment, the device may comprise a configuration for extinguishing a flame, such as a flame of a burning wick. In one embodiment, high voltage output wires (80 in FIGS. 1 and 180 in FIG. 2) are physically separate by approximately a 2-8 mm gap between the two wires. In one or more embodiments, the two wires may also be referred to as a pair of electrodes (or simply electrodes) herein. As a user activates the electrical circuit so that the power source generates an electrical shock of approximately 100 kV between the high voltage output wires, the electrical shock pressure wave extinguishes the flame on the wick. The 100 kV electrical shock is only an example of the output generated, as the device may be configured so that a lower or higher electrical shock pressure wave may be produced due to higher or lower frequency settings, thus providing a range of output values for extinguishing a flame.

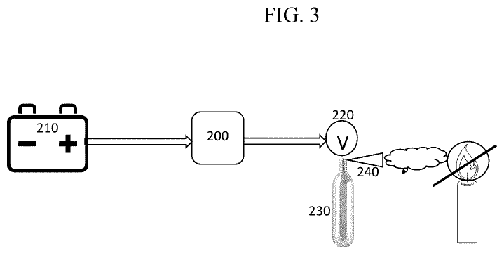

In another embodiment, the extinguishing device may contain an inline replaceable or refillable CO₂ cartridge as exemplified in FIG. 3. In this embodiment, power supply (210) is electrically interconnected with an adjustable electronic regulator (200). Regulator (200) output to valve (220) regulates the amount and duration of CO₂ output (see FIG. 3). For example, power supply (210) may comprise a battery of approximately 4 to 12 volts, but other battery sizes and configurations may also be used, depending on user preference and relative size of the device. One or more rechargeable batteries may also be incorporated within the device. In FIG. 3, regulator (200) is optionally electrically interconnected to an electronic valve (220), and valve (220) is connected to a CO₂ cartridge (230) to meter the output of CO₂. In another embodiment, one or more other flame extinguishing gases or aerosol components may be used. For example, inert gases such as nitrogen, argon, and combinations thereof, may be used. Halon gas (bromotrifluoromethane) is another example gas that may also be used, depending on user preference and cost considerations.

In an embodiment exemplified in FIG. 3, valve (220) may be triggered (switched to an on or off position) by an inline magnetic closure or pushbutton (not shown), or the like. In one embodiment, regulator (200) provides an electrical output of approximately 3.6 V to valve (220), though the range of electrical output from regulator (200) may vary from about 2 to 20 V. As an example, a rechargeable battery providing 3.6V output to valve (220) may last for approximately one month between charges, and higher voltage outputs may be provided by higher capacity batteries, such as a 12V battery or higher. The valve-controlled CO₂ gas flows through a connected outlet (240) to extinguish the flame. Outlet (240) may be a tube, a nozzle, a cone, or other similar configuration allowing metered CO₂ output. In an embodiment, CO₂ cartridge (230) is replaceable or refillable, and example CO₂ cartridges may range from about 5 g to 50 g in size/capacity. Other replaceable or refillable CO₂ cartridge sizes may also be used, depending on user preference and overall size of the device to accommodate such CO₂ cartridges.

In another embodiment, candle igniter device may comprise a system of one or more such devices, including an optional flame extinguishing device as described herein. For example, such devices may be deployed in a church, funeral parlor, wedding venue, townhall building, government facility, other community gathering halls or venues, and the like. In this embodiment, two or more candle igniter devices with associated electrical components (modular components, removable components, hard-wired components, and combinations thereof) may be arranged as a system with a centralized control system providing single-point control or multi-point control of such devices. Control of such system integrated devices according to the present disclosure may be conveniently operated via remote control(s), or even via strategically placed control boxes for operating several individual or groups of wick-containing objects. For example, in a church setting housing multiple integrated wick-containing objects, the user may ignite the wick-containing objects via an electrically interconnected control box, including one or more remotely-connected control boxes or devices. Further, one or more optional flame extinguishing devices may be combined with one or more candle igniter devices to control both flame ignition and extinguishment.

In an embodiment, a safety feature system or subsystem may also be employed in various configurations according to the present disclosure. For example, in the event a user omits or simply forgets to extinguish a flame on a wick-containing device, the chance of an accidental fire occurring is increased. In an embodiment, the safety feature may comprise automatic extinguishment due to a triggering event. For example, an automatic timer may be used with one or more of the described embodiments herein or variations thereof, such that the timer is configured to allow the wick-containing device to burn for a specified period of time, then activation of the timer's automatic extinguishment feature causes the circuit to engage the extinguishment feature, such as by triggering release of the CO₂ gas or other gas used with the device. In another embodiment, the timer may trigger the release of the electrical shock pressure wave as described herein to extinguish the flame.

Further, in one or more embodiments, the safety feature system or subsystem may employ a remote connection, such as via Bluetooth or Wi-Fi technology, or similar wireless technology. Connection of the extinguishing device system or subsystem through wireless technology also enables use of a remote notification system, so that a user may manually trigger the extinguishment of the flame through wireless connected devices, such as a smartphone or other Wi-Fi connected apparatus. A wireless sensor, including a remote sensor notification device, may be incorporated with the flame extinguishing device to also provide notification to a computer-based monitoring system, so that multiple flame extinguishing devices may be used simultaneously to extinguish multiple wick-containing devices, such as a group of candles, lanterns, gas lamps, and the like. In another embodiment, a wick-containing device may contain an integrated sensor. For example, a candle having an integrated sensor may trigger a notification event when the candle wax reaches a lower limit to expose the VVi-Fi-connected sensor that then emits a triggering event to a local or remote control panel/device, so that the flame may be manually or automatically extinguished according to the present disclosure. Smartphone apps may also be employed to interface with the sensor to notify a user of an existing flame on a wick-containing or other related device.

One of ordinary skill in the art will readily understand that any ordering of method steps implied by the drawings or description herein is not to be construed as limiting or requiring the disclosed methods to performing the steps in that order. Rather, the various steps of each of the methods disclosed herein can be performed in any of a variety of sequences. In addition, as the described methods are merely exemplary embodiments, various other methods that include additional steps or include fewer steps are also within the scope of the present invention.

Any publications and patent applications mentioned in the specification are indicative of the level of those skilled in the art to which this invention pertains. All publications and patent applications are hereby incorporated by reference to the same extent as if each individual publication or patent application was specifically and individually indicated to be incorporated by reference.

Although the foregoing invention has been described in some detail by way of illustration and example for purposes of clarity of understanding, certain changes and modifications may be practiced within the scope of the appended claims. Also, it should be understood that numerous changes may be made within the spirit and scope of the inventive concepts described.

1. An electronic arc generating system comprising:
a power supply;
a transistor;
a diode;
a transformer;
a pair of electrodes;
a low-voltage generating subsystem comprising a first switch and a first resistor, wherein said low-voltage generating subsystem is configured to ignite a combustible component; and
a high-voltage generating subsystem comprising a second switch and a second resistor, wherein said high-voltage generating subsystem is configured to extinguish a flame of a combustible component,
wherein said power supply, said transistor, said diode, said transformer, said pair of electrodes, said low-voltage generating subsystem and said high-voltage generating subsystem, are all electrically interconnected.

2. An electronic arc generating system according to claim 1, wherein said power supply is a rechargeable power supply.

3. An electronic arc generating system according to claim 1, wherein said power supply is a removable power supply.

4. An electronic arc generating system according to claim 1, wherein said combustible component comprises a candle wick.

5. An electronic arc generating system according to claim 1, wherein said combustible component comprises a gaseous component.

6. An electronic arc generating system according to claim 1, wherein said low-voltage generating subsystem produces an output across said pair of electrodes of about 20 kilovolts.

7. An electronic arc generating system according to claim 1, wherein said high-voltage generating subsystem produces an output across said pair of electrodes of about 60 to 70 kilovolts.

8. A combination electronic arc ignition and extinguishment system comprising:
a power supply;
a transistor;
a diode;
a transformer;
a pair of electrodes;
a low-voltage generating subsystem comprising a first switch and a first resistor; and
a high-voltage generating subsystem comprising a second switch and a second resistor,
wherein said power supply, said transistor, said diode, said transformer, said pair of electrodes, said low-voltage generating subsystem and said high-voltage generating subsystem, are all electrically interconnected.

9. A combination electronic arc ignition and extinguishment system according to claim 8, wherein said low-voltage generating subsystem is configured to ignite a combustible component.

10. A combination electronic arc ignition and extinguishment system according to claim 8, wherein said high-voltage generating subsystem is configured to extinguish a flame of a combustible component.

11. A combination electronic arc ignition and extinguishment system according to claim 8, wherein said power supply is a rechargeable power supply.

12. A combination electronic arc ignition and extinguishment system according to claim 8, wherein said power supply is a removable power supply.

13. A combination electronic arc ignition and extinguishment system according to claim 8, wherein said combustible component comprises a candle wick.

14. A combination electronic arc ignition and extinguishment system according to claim 8, wherein said combustible component comprises a gaseous component.

15. A combination electronic arc ignition and extinguishment system according to claim 8, wherein said low-voltage generating subsystem produces an output across said pair of electrodes of about 20 kilovolts.

16. A combination electronic arc ignition and extinguishment system according to claim 8, wherein said high-voltage generating subsystem produces an output across said pair of electrodes of about 60 to 70 kilovolts.

17. A combination electronic arc ignition and extinguishment system comprising:
a power supply;
a transistor;
a diode;
a transformer;
a pair of electrodes;
a low-voltage generating subsystem comprising a first resistor;
a high-voltage generating subsystem comprising a second resistor; and
a 3-way switch located upstream of said low-voltage generating subsystem and said high-voltage generating subsystem, wherein said 3-way switch is configured to separately engage said low-voltage generating subsystem or said high-voltage generating subsystem, or to simultaneously engage both said low-voltage generating subsystem and said high-voltage generating subsystem,
wherein said power supply, said transistor, said diode, said transformer, said pair of electrodes, said 3-way switch, said low-voltage generating subsystem and said high-voltage generating subsystem, are all electrically interconnected.

18. A combination electronic arc ignition and extinguishment system according to claim 17, wherein said first resistor of said low-voltage generating subsystem provides a resistance value of about 50 ohms.

19. A combination electronic arc ignition and extinguishment system according to claim 17, wherein said second resistor of said high-voltage generating subsystem provides a resistance value of about 100 ohms.
